(19) United States
(12) Patent Application Publication
(10) Pub. No.: US 2025/0190858 A1
(43) Pub. Date: Jun. 12, 2025

(54) License Analysis for Artificial Intelligence (AI) Generated Compositions

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); Alexander Michael Hoole, Vancouver (CA); Carl Emil Orm Wareus, Malmo (SE)

(73) Assignee: MICRO FOCUS LLC, WILMINGTON, DE (US)

(21) Appl. No.: 18/604,669

(22) Filed: Mar. 14, 2024

Related U.S. Application Data
(63) Continuation-in-part of application No. PCT/US2023/082668, filed on Dec. 6, 2023.

(51) Int. Cl. G06N 20/00

(52) U.S. Cl. CPC G06N 20/00

(57) ABSTRACT

A composition is generated by an AI algorithm. For example, the AI generated composition may be an image that was generated by the AI algorithm. The AI generated composition is analyzed, using a similarity algorithm, to identify a snippet of the AI generated composition that is the same or similar to snippet of a composition used to train the AI algorithm. The license information associated with the snippet of the composition used to initially train the AI algorithm is identified. Licensing information for the AI generated composition that comprises the licensing information associated with the identified snippet of the AI generated composition is generated. The licensing information is associated with the AI generated composition. For example, the licensing information may be used to track the AI generated composition and/or copies of the AI generated composition.

### CROSS REFERENCE TO RELATED APPLICATION

The present application is a continuation-in-part of PCT Application Serial No. PCT/US2023/082668, filed Dec. 6, 2023, entitled “Supply Chain Analysis for Artificial Intelligence (AI) Generated Source Code”, which is incorporated herein by this reference in its entirety.

Cross reference is made to U.S. patent application Ser. No. 18/228,228, filed Jul. 31, 2023, entitled “Using Watermarks to Identify a Chain of Title in Media”, which is incorporated herein by this reference in its entirety.

### FIELD

The disclosure relates generally to managing licenses and particularly to management of licenses for material generated by Artificial Intelligence algorithms.

### BACKGROUND

One of the key issues today for AI algorithms is that it is difficult to identify which sources were used to generate compositions (e.g., a document or image) produced by AI algorithms. This is because Large Language Models (LLMs) may have hundreds of or even thousands of layers where the source information between the layers (i.e., the compositions used to train the AI algorithm) is lost.

### SUMMARY

These and other needs are addressed by the various embodiments and configurations of the present disclosure. The present disclosure can provide a number of advantages depending on the particular configuration. These and other advantages will be apparent from the disclosure contained herein.

A composition is generated by an AI algorithm. For example, the AI generated composition may be an image that was generated by the AI algorithm. The AI generated composition is analyzed, using a similarity algorithm, to identify a snippet of the AI generated composition that is the same or similar to snippet of a composition used to train the AI algorithm. The license information associated with the snippet of the composition used to initially train the AI algorithm is identified. Licensing information for the AI generated composition that comprises the licensing information associated with the identified snippet of the AI generated composition is generated. The licensing information is associated with the AI generated composition. For example, the licensing information may be used to track the AI generated composition and/or copies of the AI generated composition.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “composition” may include any type of composition that is in an electronic format, such as, a document, an image, a video, an audio work (e.g., music), a musical composition, an audio stream, a text stream, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for creating license information for Artificial Intelligence (AI) generated compositions.

FIG. 2 is a block diagram of a second illustrative system for creating license information for AI generated compositions.

FIG. 3 is a flow diagram of a process creating license information for AI generated compositions.

FIG. 4 is a flow diagram of a process for identifying source(s) of AI generated compositions using vectors.

FIG. 5 is a flow diagram of a process for identifying source(s) of AI generated compositions using hashes of snippets of compositions.

FIG. 6 is a flow diagram of a process for identifying source(s) of AI generated compositions using snippets of compositions.

FIG. 7 is a flow diagram of a process for determining licenses associated with AI generated compositions.

FIG. 8 is a flow diagram of a process for determining information associated with AI generated compositions.

FIG. 9 is a flow diagram of a process for determining information associated with training an AI algorithm.

FIG. 10 is a diagram of a blockchain for storing information associated with training an AI algorithm.

FIG. 11 is a diagram of a blockchain for storing information associated with AI generated compositions.

FIG. 12 is a diagram of a branched blockchain 131 for tracking ownership of copies of an AI generated composition.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

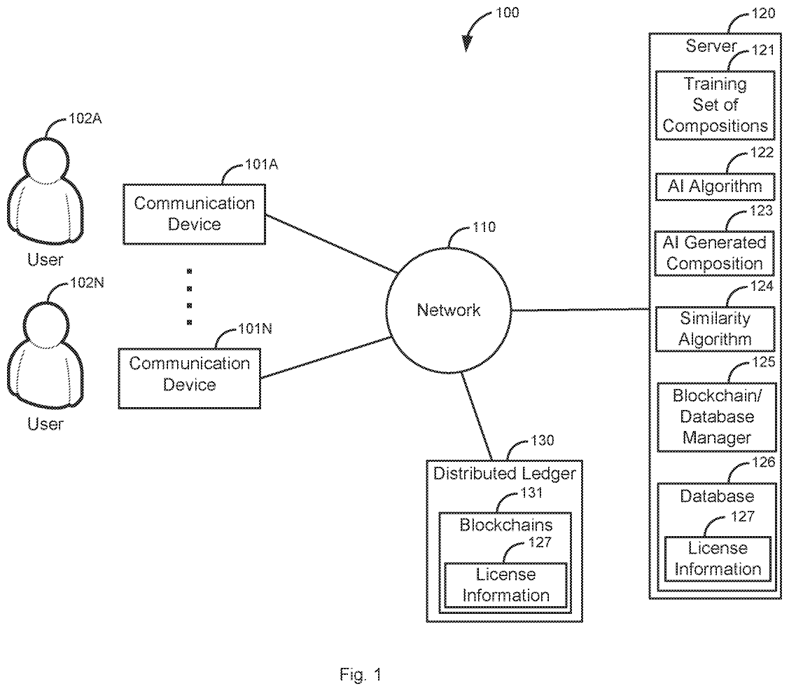

FIG. 1 is a block diagram of a first illustrative system for creating license information 127 for Artificial Intelligence (AI) generated compositions 123. The first illustrative system 100 comprises communication devices 101A-101N, a network 110, a server 120, and a distributed ledger 130. In addition, users 102A-102N are shown for convenience.

The communication devices 101A-101N can be or may include any user device that can communicate on the network 110, such as a Personal Computer (PC), a cellular telephone, a Personal Digital Assistant (PDA), a tablet device, a notebook device, a laptop computer, a smartphone, and/or the like. As shown in FIG. 1, any number of communication devices 101A-101N may be connected to the network 110, including only a single communication device 101. The users 102A-102N use the communication devices 101A-101N to communicate to the server 120.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network 110 configured to carry messages via packets and/or circuit switched communications.

The server 120 may be any type of device that can be accessed by the communication devices 101A-101N. The server 120 may be used by the user 102 to generate/manage license information 127 and AI generated compositions 123. The server 120 comprises a training set of compositions 121, an AI algorithm 122, an AI generated composition 123, a similarity algorithm 124, a blockchain/database manager 125, and a database 126. In one embodiment, the server 120 may be a communication device 101 (e.g., a user's laptop computer). In addition, the different elements 121-127 may be distributed between a communication device(s) 101 and the server 120.

The training set of compositions 121 is any number of compositions used to train the AI algorithm 122. The training set of compositions 121 is shown on the server 120. However, the training set of compositions 121 may reside in other places, such as a composition repository, on a communication device 101, on anther server, and/or the like. The training set of compositions 121 may be subject to various types of licenses, such as proprietary licenses, open-source licenses (e.g., the Open Audio License, the Creative Commons License, etc.), public domain licenses, copyright licenses, and/or the like. The training set of compositions 121 may include specific types of compositions or mixed types of compositions, such as images, videos, music, documents, audio information, and/or the like.

In many embodiments, the training set of compositions 121 may comprise an extremely large number of compositions. For example, the training set of compositions 121 may comprise millions of compositions. This makes determining which compositions were actually used to create the AI generated composition 121 a task that cannot be accomplished manually.

The AI algorithm 122 may be any type of AI algorithm 122 that can generate a composition 123, such as ChatGPT, Music LM, Amper Music, DALL-E, Craiyon, Midjourney, and/or the like. The AI algorithm 122 is trained using the training set of compositions 121. The AI algorithm 122 generates the AI generated composition 123 based on the training set of compositions 121.

The similarity algorithm 124 may comprise one or more algorithms that are used to identify similarities between the training set of compositions 121 and the AI generated composition 123. The similarity algorithm 124 may comprises various types of algorithms that use vectors, hashes, snippets, and/or the like. The similarity algorithm 124 may run multiple algorithms in parallel. For example, the similarity algorithm 124 may comprise a vector algorithm and a hashing algorithm that run in parallel.

The similarity algorithm 124 is used to overcome problems with existing AI algorithms 122 that generate compositions. With the complexity of Large Language Models (LLM) AI algorithms 122, it is currently not possible to identify what compositions in the training set of compositions 121 produced the actual AI generated composition 123. This is because of the many layers within the LLMs and the fact that each layer does not retain the information of the previous layer.

The blockchain/database manager 125 may be any hardware coupled with software that can manage the AI processes described herein and manage the retrieval/storage of information in the database 126 and/or the distributed ledger 130/blockchain 131. The blockchain/database manager 125 can be used create the blockchains 131 in the distributed ledger 130. In addition, the blockchain/database manager 125 may add information to the license information 127 in the blockchains 131, add blocks to the blockchains 131 in the distributed ledger 130, and/or the like. Likewise, the blockchain/database manager 125 may add information associated with the license information 127 in the database 126. If a distributed ledger 130 is used, there may be multiple instances of the blockchain/database manager in each node that has a blockchain 131.

The database 126 may be any type of database 126 that can store license information 127, such as a relational database, a hierarchical database, an analytical database, a file system, and/or the like. The database 126 further comprises the license information 127. The license information 127 may be stored in different structures/tables in the database 126.

The license information 127 may include license information 127 of the compositions of the training set of compositions 121. For example, the license information 127 may comprise copyright license(s), open-source license(s), public domain license(s), commercial license(s), third party license(s), and/or the like.

The distributed ledger 130 comprises two or more nodes that store copies of the blockchains 131. The nodes use a consensus vote for adding blocks to the blockchains 131. The distributed ledger 130 is shown separate from the server 120. However, the server 120 may be a node that has a copy of the blockchain 131 in the distributed ledger 130. The blockchains 131 comprise the license information 127 that is stored in different blocks that are stored as part of the blockchains 131 in the distributed ledger 130.

The distributed ledger 130 may be a private distributed ledger 130 and/or a public distributed ledger 130. For example, the distributed ledger 130 may be a private distributed ledger 130 that is owned by a single entity (e.g., a corporation). Alternatively, the distributed ledger 130 may be a public distributed ledger 130 that can be publicly viewed by anyone. The distributed ledger 130 may be a semi-private distributed ledger 130.

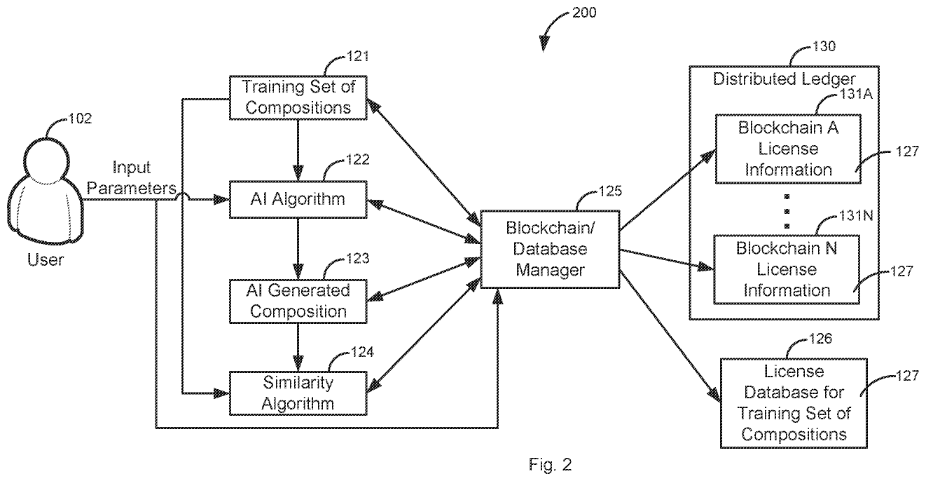

FIG. 2 is a block diagram of a second illustrative system for creating license information 127 for AI generated compositions 123. When the AI algorithm 122 is used to generate the AI generated composition 123, various aspects of the AI algorithm 122/AI generated composition 123 are tracked and stored in the distributed ledger 130/blockchains 131A-131N and/or the database 126.

FIG. 2 comprises the training set of compositions 121, the AI algorithm 122, the AI generated composition 123, the similarity algorithm 124, the blockchain/database manager 125, the distributed ledger 130 that includes the blockchains 131A-131N (that have a replicated license information 127), and the database 126 that has the license information 127. In FIG. 2, the training set of compositions 121 is used to train the AI algorithm 122, which in turn generates the AI generated composition 123 based on input parameters from the user 102 (or could be from an automated source or another AI algorithm 122). The similarity algorithm 124 determines similarities between the AI generated composition 123 and the training set of compositions 121. The blockchain/database manager 125 then takes different types of information from the training set of compositions 121, the AI algorithm, 122 the AI generated composition 123, the similarity algorithm 124, and the user input parameters to create the license information 127. While described using a distributed ledger 130, the license information 127 may reside in a single blockchain 131.

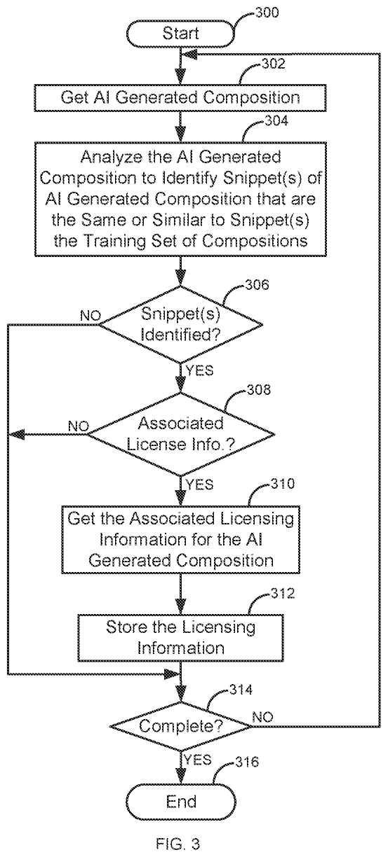

FIG. 3 is a flow diagram of a process creating license information 127 for AI generated compositions 123. Illustratively, the communication devices 101A-101N, the server 120, the training set of compositions 121, the AI algorithm 122, the AI generated composition 123, the similarity algorithm 124, the blockchain/database manager 125, the database 126, the license information 127, the distributed ledger 130, and the blockchains 131A-131N are stored-program-controlled entities, such as a computer or microprocessor, which performs the method of FIGS. 3-12 and the processes described herein by executing program instructions stored in a computer readable storage medium, such as a memory (i.e., a computer memory, a hard disk, and/or the like). Although the methods described in FIGS. 3-12 are shown in a specific order, one of skill in the art would recognize that the steps in FIGS. 3-12 may be implemented in different orders and/or be implemented in a multi-threaded environment. Moreover, various steps may be omitted or added based on implementation.

The process starts in step 300. The similarity algorithm 124 gets, in step 302, the AI generated composition 123. The similarity algorithm 124 analyzes the AI generated composition 123 to identify one or more snippets of the AI generated composition 123 that are the same or similar to snippets the training set of compositions 121 in step 304. The snippets may be different sizes depending upon implementation. For example, the similarity algorithm 124 may be a vector-based algorithm that takes snippets (e.g., 30 byte snippets) of the training set of compositions 121 and the AI generated composition 123 to produce vectors (e.g., floating-point vectors). The vectors from the training set of compositions 121 are compared to the vectors of the AI generated composition 123 to identify exact matches and/or similarities (e.g., identical floating-point vectors or close floating-point vectors). Similar vectors refer to the vectors being close in vector-space. The similarity algorithm 124 may be used to determine the distance between vectors, such as Euclidian distance, or Cosine similarity.

The similarity algorithm 124 determines, in step 306, if there are any matching/similar snippets in the AI generated composition 123. If there were not any matching/similar snippets in step 306, the process goes to step 314. Otherwise, if there are one or more matching/similar snippets in step 306, the blockchain/database manager 125 determines, in step 308 if there is any associated licensing information 127 (i.e., licensing information 127 associated with one or more snippets of the training set of compositions 121).

If there is no associated licensing information 127 in step 308, the process goes to step 314. Otherwise, if there is associated licensing information 127 in step 308, the blockchain/database manager 125 gets the associated licensing information 127 for the corresponding composition(s) in the training set of compositions 121 in step 310. The blockchain/database manager 125 stores off the associated licensing information 127 in step 312.

The license information 127 may include information associated with a specific version of the AI algorithm 122, information associated with a specification version of the AI generated composition 123, information associated with a specific time that input data was used to generated the AI generated composition 123 (e.g., when nothing else has changed (i.e., the training set of compositions 121, the AI algorithm version, the input data/parameters used to generate the AI generated composition 123, etc. are the same)), information associated with the input data/parameters used to generate the AI generated composition 123, a specific version of the AI algorithm 122, a specific version of the training set of compositions 121, information about the AI algorithm 122, license information 127 about the AI generated composition 123, a likely license associated with the identified snippet of source code generated by the AI algorithm 122, a hash of the snippet of AI generated composition 123, the snippet of AI generated composition 123, vector(s) generated by the similarity algorithm 124, the AI generated composition 123, release information, and/or the like. This may include any links to this information. The process then goes to step 314.

Because all this information is tracked, the license information 127 can identify critical information. For example, the blockchain/database manager 125 may identify the AI generated composition 123, the version of the AI algorithm 122, the training set of compositions 121 used to train the AI algorithm 122, the input parameters/data, the time the AI generated composition 123 was created (because different AI generated composition 123 may be generated when nothing else has changed), the user 102 who generated the input, and/or the like to properly create the license information 127.

The license information 127 of step 310 may comprise information for the AI generated composition 123 from different versions of AI generated composition 123 where only the input data/parameters have changed. Another example is where the license information 127 comprises two or more sets of AI generated compositions 123 that came from two or more of the training sets of compositions 121. The license information 127 may include where the AI generated composition 123 has been modified. For example, the user 102 may modify the AI generated composition 123 by adding to the AI generated composition 123, changing the AI generated composition 123, removing some of the AI generated composition 123, and/or the like.

The blockchain/database manager 125 determines, in step 314, if the process is complete. If the process is not complete in step 314, the process goes back to step 302. Otherwise, if the process is complete in step 314, the process ends in step 316.

In one embodiment, going back to step 302 may include regenerating a new AI generated composition 123 using a different input or the same input to see if there are different associated licenses. The result may be that a different set of snippets/licenses may be identified in steps 306/308. The user 102 may want to use different licenses for different reasons, such as, for a lower royalty payment. In addition, the AI generated compositions may be included in future training sets of compositions 121.

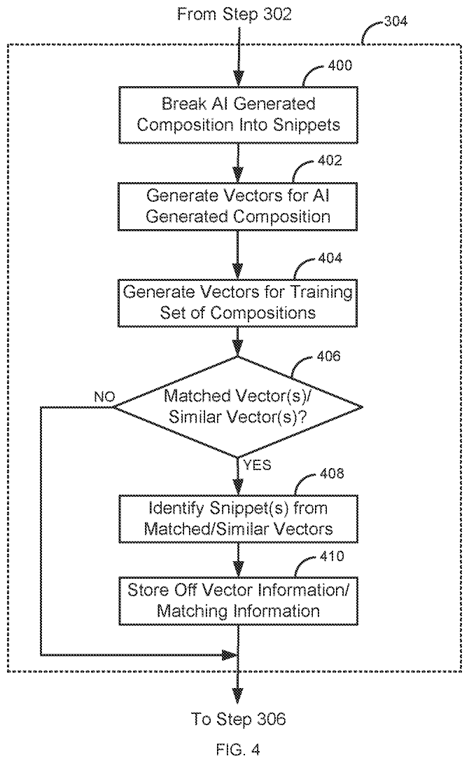

FIG. 4 is a flow diagram of a process for identifying source(s) of AI generated compositions 123 using vectors. The process of FIG. 4 is an exemplary embodiment of step 304 of FIG. 3 where the similarity algorithm 124 is a vector-based similarity algorithm 124.

After getting the AI generated composition 123 in step 302, the AI generated composition 123 is broken into snippets in step 400. The similarity algorithm 124 generates vectors for the AI generated composition 123 (e.g., by creating floating-point vectors for snippets of the AI generated composition 123) in step 402. The similarity algorithm 124 generates vectors for the training set of compositions 121 (e.g., by creating floating point vectors and/or integer vectors for snippets of the training set of compositions 121) in step 404. The similarity algorithm 124 determines, in step 406, if there are any matched vector(s)/similar vectors in step 406. The determination of step 406 may use a threshold to determine similar vectors.

If there are no matched or similar vectors in step 406, the process goes to step 306. Otherwise, if there are one or more matched or similar vectors in step 406, the snippet(s) of the training set of compositions 121 are identified based on the matched or similar vectors in step 408. The vector information/matching information is then stored off in step 410 and the process goes to step 306.

The stored off information of step 410 may include the matched vector(s) (e.g., the floating-point data), the matched snippets of the compositions in the training set of compositions 121, matching vector information generated by the similarity algorithm 124, license information 127, links to any of the above, a threshold used for matching vectors (e.g., how close are the two floating point vectors or integers), and/or the like. The information stored off in step 410 is part of the license information 127 of step 310.

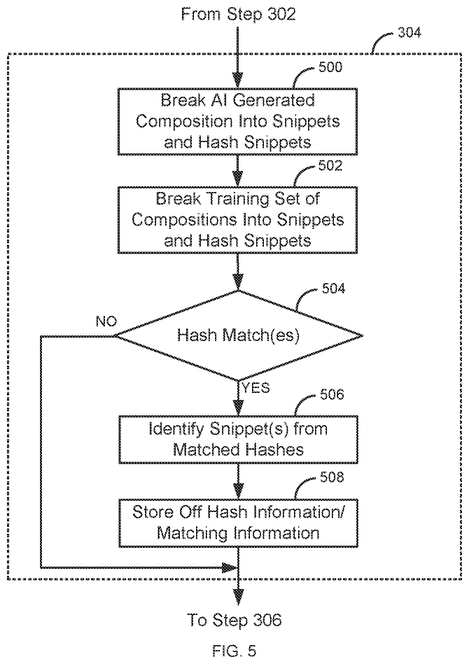

FIG. 5 is a flow diagram of a process for identifying source(s) of AI generated compositions 123 using hashes of snippets of compositions. The process of FIG. 5 is an exemplary embodiment of step 304 of FIG. 3 where the similarity algorithm 124 is a snippet hash-based similarity algorithm 124.

After getting the AI generated composition 123 in step 302, the similarity algorithm 124 breaks the AI generated composition 123 into snippets and then generates hashes of the snippets in step 500. The similarity algorithm 124 breaks the training set of compositions 121 into snippets and then generates hashes of the snippets in step 502.

The similarity algorithm 124 identifies, in step 504, if there are any hash matches by comparing the snippets from the AI generated composition 123 to the snippets of the training set of compositions 121. For example, a match is where a hash of a snippet of the training set of compositions 121 is the same as a hash for a snippet the AI generated composition 123. If there are not any matches in step 504, the process goes to step 306. Otherwise, if there is one or more matches in step 504, the similarity algorithm 124 identifies the snippet(s) in the training set of compositions 121 that match the snippets from the AI generated composition 123 in step 506. The matching snippets, hash information, license information 127, and/or other matching information are then stored off in step 508. The information stored off in step 508 is used to generate the license information 127 in step 310. The process then goes to step 306.

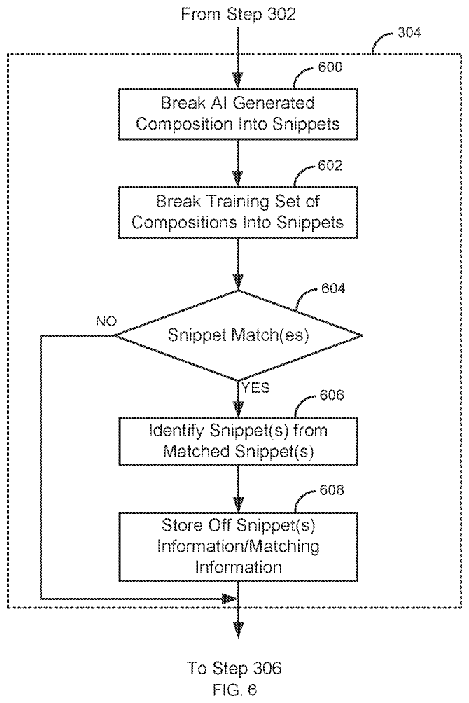

FIG. 6 is a flow diagram of a process for identifying source(s) of AI generated compositions 123 using snippets of compositions. The process of FIG. 6 is an exemplary embodiment of step 304 of FIG. 3 where the similarity algorithm 124 is a snippet-based similarity algorithm 124.

After getting the AI generated composition 123 in step 302, the similarity algorithm 124 breaks the AI generated composition 123 into snippets in step 600. The similarity algorithm 124 breaks the training set of compositions 121 into snippets in step 602. The process of breaking the training set of compositions 121 into snippets, in step 602, may be done previously. In other words, the snippets for the training set of compositions may be a pre-generated set of snippets for the training set of compositions.

The similarity algorithm 124 identifies, in step 604 if there are any snippet matches. For example, a match is where a snippet of the training set of compositions 121 is the same or similar to a snippet from the AI generated composition 123. If there is not a match in step 604, the process goes to step 306. Otherwise, if there is one or more matches in step 604, the similarity algorithm 124 identifies the snippet(s) in the training set of compositions 121 that match the snippets from the AI generated composition 123 in step 606. The matching snippets, licensing information, thresholds, and/or other matching information are then stored off in step 608. The information stored off in step 608 is used to generate the license information 127 in step 310. The process then goes to step 306.

The processes of FIGS. 4-6 may be fine-tuned by changing the window size (i.e., the size of the snippets (e.g., lines/characters, file, class, function/method, or the like)). In addition, the processes of FIGS. 4-6 may use over-lapping windows/snippets. For example, for two consecutive snippets (a first and second snippet), there may be one overlapping snippet that has a portion of the first snippet and a portion of the second snippet. In addition, the threshold may be lower based on the license type. For example, if the threshold may be lower for a Creative Commons License versus another type of license.

In addition, the system could account for snippets of compositions that are considered trivial compositions (i.e., common place snippets), which are considered non-copyrightable compositions based on identification of the snippets. For example, the similarity algorithm 124 could prefer snippets that are less frequent (e.g., only one instance) in the training set, over more common snippets. This could be achieved through an “inverse document frequency” mechanism (e.g., used today in the TF-IDF search algorithm).

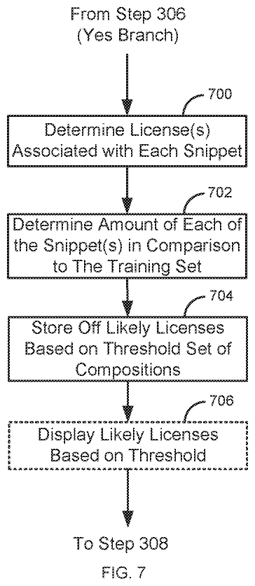

FIG. 7 is a flow diagram of a process for determining licenses associated with AI generated compositions 123. The process of FIG. 7 goes between step 306 (yes branch) and step 308. After identifying one or more matching/similar code snippets in step 306, the blockchain/database manager 125 determines license(s) associated with each matched/similar snippet in the training set of compositions 121 in step 700. There can be more than one license associated with a matched snippet. For example, an open-source composition may be licensed under multiple open-source licenses.

The blockchain/database manager 125 determines the amount of each of the snippets of the same type of license in comparison to the training set of compositions 121 in step 702 (a likely license). For example, if there are two snippet matches that are for the Creative Commons 1.0 license, the matched amounts are added together (e.g., 2% of the training set of compositions 121 for snippet A and 3% of the training set of compositions 121 for snippet B would total 5%). Another example is where there is only a single snippet that is 2% of the training set of compositions 121 and the AI generated composition 123 would be identified as being derived from 2% of the associated license. If there are multiple licenses associated with the same snippet, the likely

licenses can be identified as being licensed for either. For example, if snippet one is identified for 2% of the training set of compositions 121 and is licensed under the Creative Commons 1.0 license and snippet two is licensed under the Open Audio 1.0 license and the Creative Commons 1.0 license, the percentages may be shown as 2-4% Creative Commons and 0-2% Open Audio 1.0 (a varying percentage). The user 102 may be given the option to select which license to use so that the actual percentages for the likely licenses match the user selected licenses. While the above example is described using open-source licenses, this process may also apply to any type of license.

The likely license(s) are stored off in step 704. The stored off likely licenses may be stored off based on a threshold for generating the license information 127. For example, the threshold may be 0.5% of the training set of compositions 121. The threshold may be user defined or may be predefined.

The likely licenses may then be optionally displayed to the user 102 in step 706. In one embodiment, the likely licenses may be displayed based on the threshold in step 706. In addition, the threshold may be displayed to the user 102. The user 102 may also have the option to change the threshold to see what licenses are be covered under a specific threshold. The process then goes to step 308.

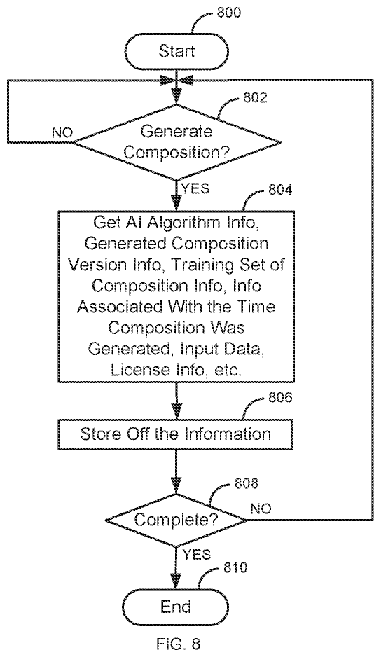

FIG. 8 is a flow diagram of a process for determining information associated with AI generated compositions 123. The process starts in step 800. The AI algorithm 122 determines, in step 802, if a request to generate the AI generated composition 123 has been received. If a request has not been received to generate the AI generated composition 123, the process of step 802 repeats. Otherwise, if a request to generate the AI generated composition 123 is received in step 802, the blockchain/database manager 125 gets various types of information associated with the generation of the AI generated composition 123 in step 804. For example, the blockchain/database manager 125 may get information associated with the AI algorithm 122 (e.g., a version number), generated composition information (e.g., a version number), information associated with the training set of compositions 121 (e.g., versions/dates of compositions of the training set of compositions 121), a time when the AI generated composition 123 was generated, input data/parameters (e.g., information input by the user 102 to generate the AI generated composition 123), license information 127 associated with the training set of compositions 121 (e.g., open-source license information 127, third-party license information 127, proprietary license information 127, copyright license information 127, public domain license information, and/or the like), user information, location information, and/or the like.

The information of step 804 is then stored off in step 806. The stored off information may be later used to get the license information 127 as described in step 310.

The blockchain/database manager 125 determines, in step 808, if the process is complete. If the process is not complete in step 808, the process goes back to step 802. Otherwise, if the process is complete in step 808, the process ends in step 810.

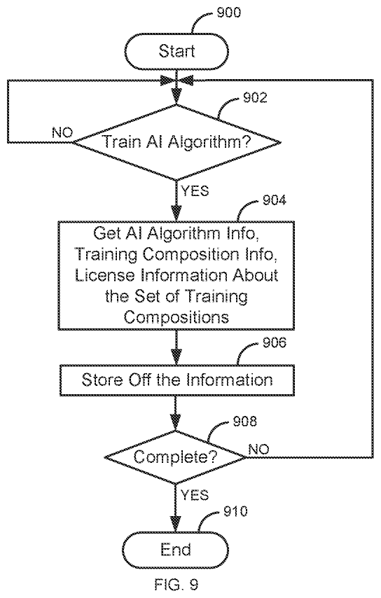

FIG. 9 is a flow diagram of a process for determining information associated with training an AI algorithm 122. The process starts in step 900. The AI algorithm 122 determines, in step 902, whether to train the AI algorithm 122. If the AI algorithm 122 is not to be trained, the process of step 902 repeats.

Otherwise, if the AI algorithm 122 is to be trained in step 902, the blockchain/database manager 125 gets information associated with training the AI algorithm 122 in step 904. For example, the information may be about the training set of compositions 121 (e.g., version numbers, hashes of compositions, composition creation dates, etc.), license information 127 about the training set of compositions 121 (e.g., open-source license information 127, proprietary license information 127, third-party license information 127, copyright license information 127, public domain license information, and/or the like), user information (e.g., the user 102 who initiated the training of the AI algorithm 122), the time the AI algorithm 122 was trained, a country that training of the AI algorithm 122 took place, and other information (e.g., the version of the AI algorithm 122 when trained), and/or the like.

The information of step 904 is then stored off in step 906. The stored off information may be later used when getting the license information 127 as described in step 310.

The blockchain/database manager 125 determines, in step 908, if the process is complete. If the process is not complete in step 908, the process goes back to step 902. Otherwise, if the process is complete in step 908, the process ends in step 910.

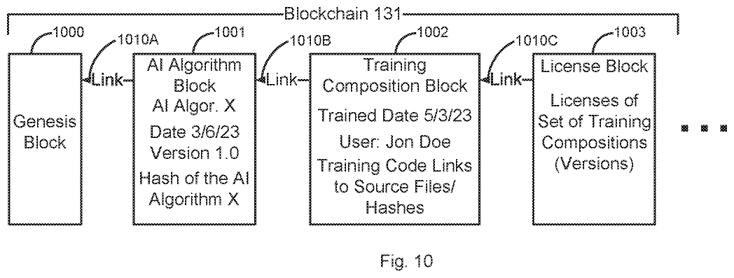

FIG. 10 is a diagram of a blockchain 131 for storing information associated with training an AI algorithm 122. The blockchain 131 is an exemplary example of the replicated blockchains 131A-131N in the distributed ledger 130. The blockchain 131 comprises a genesis block 1000, an AI algorithm block 1001, a training composition block 1002, and a license block 1003. The blocks 1000-1003 are linked together by links 1010A-1010C. The links 1010A-1010C are links to hashes (not shown) that are traditionally used in blockchains 131.

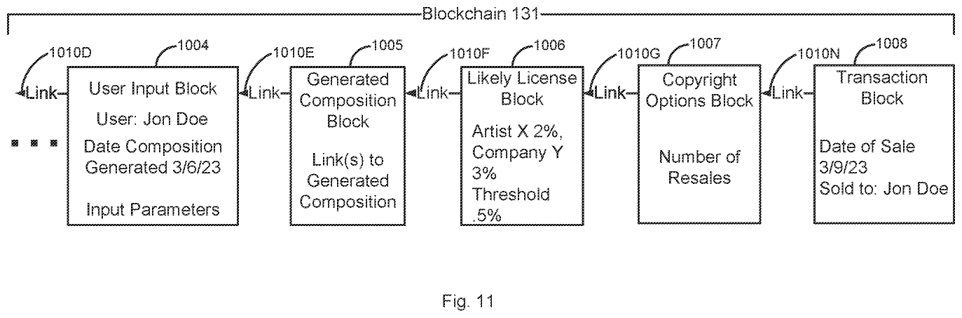

The blockchain/database manager 125 creates the genesis block 1000. The genesis block 1000 is generated to start a new blockchain 131 for tracking the license information 127 for the AI generated composition 123. In FIG. 10, some of the license information 127 is stored in the blocks 1000-1003. However, additional blocks may be added to the blockchains 131A-131N/license information 127 in the database 126 as described in FIG. 11 and herein.

Once the genesis block 1000 is created, the AI algorithm block 1001 is created in the blockchain 131. The AI algorithm block 1001 may include various types of information associated with the AI algorithm 122, such as the name of the AI algorithm 122 (e.g., AI Algorithm X), a version of the AI algorithm 122 (e.g., version 1.0), a creation date of the AI algorithm 122 (e.g., Mar. 6, 2023), a hash of the AI algorithm 122, the user 102 executing the AI algorithm 122, source code used to create the AI algorithm 122, hashes of source code used to create the AI algorithm 122, a country of origin of the AI algorithm 122, and/or the like. In one embodiment, the genesis block 1000 may be the AI algorithm block 1001.

When the AI algorithm 122 is trained, the training composition block 1002 may be added to the blockchain 131. The training composition block 1002 may comprise various types of information, such as the user 102 who trained the AI algorithm 122, the date the AI algorithm 122 was trained, links to the training set of compositions 121 (e.g., to different compositions), the actual training set of compositions 121, hashes of the training set of compositions 121, a country of origin of the user 102 who trained the AI algorithm 122, a country the AI algorithm 122 was trained in, and/or the like.

As part of the training process, licenses associated with the training set of compositions 121 are identified. For example, a Creative Commons license may be associated with a specific composition of the training set of compositions 121. The license block 1003 is added to the blockchain 131 based on the identified licenses. The license block 1003 contains all (or some) of the identified licenses associated with the training set of compositions 121. The license block 1003 may have links to the licenses. There may be multiple license blocks 1003. For example, there may be a license block for each composition in the training set of compositions 121.

Other types of blocks that may be added to the blockchain 131 may include a licenses filtered out block. The licenses filtered out block may be based on a filter that is used to filter the training set of compositions 121 to exclude specific licenses and their respective compositions when training the AI algorithm 122.

FIG. 11 is a diagram of a blockchain 131 for storing information associated with AI generated compositions 123. FIG. 11 is a continuation of the blockchain 131 described in FIG. 10. The blockchain 131 further comprises a user input block 1004, a generated composition block 1005, a likely license block 1006, a copyright options block 1007, and a transaction block 1008. The blocks 1004-1008 are linked together by links 1010D-1010N.

Once the AI algorithm 122 is trained and the 102 user 102 now wants to generate the AI generated composition 123, additional license information 127 may be tracked in the blockchain 131 as shown in FIG. 11. As part of the process for generating the AI generated composition 123, the user 102 may provide various types of parameters/data to generate the AI generated composition 123. For example, the user 102 may provide input to create an image based on the paintings of the artists Vincent van Goh and Pablo Picasso that includes a woman that is in Central Park in New York City. The input information may include other information, such as an additional input image, music to be associated with the generated composition 123, and/or the like. This results in the creation of the user input block 1004. The user input block 1004 includes the user 102 (e.g., Jon Doe) who generated the AI generated composition 123, the date the AI generated composition 123 was generated (e.g., Mar. 6, 2023), the input parameters (including prompts/parameters and additional input compositions such as image(s)/music/file(s)), and/or the like.

The user input block 1004 may be where the input was not from a user 102, but from an AI algorithm 122 or automated process. In this case, the user input block 1004 would be an AI input block instead of the user input block 1004.

The generated composition block 1005 is created when the AI generated composition 123 is generated. The generated composition block 1005 may comprise the actual AI generated composition 123, link(s) to the AI generated composition 123, hashes of the AI generated composition 123, a version number of the AI generated composition 123, a country of origin of the user 102 who initiated the generation of the AI generated composition 123, a country the AI generated composition 123 was generated in, and/or the like.

As the similarity algorithm 124 identifies the snippets in the training set of compositions 121 as described herein, the likely license block 1006 is added to the blockchain 131. The licenses in the likely license block 1006 are based on the matching of the vectors/hashes/snippets of the AI generated composition 123 to the vectors/hashes/snippets of training set of compositions 121. In this example, there were two matching licenses: 1) a license from Artist X 2%, and 2) a license from company Y 3% (licensors).

The likely license block 1006 may include varying percentages. For example, if there was only a single snippet of a composition of the training set of compositions 121 was identified at 1% and the composition can be licensed under multiple licenses (e.g., the Creative Commons 1.0 license and the Open Audio 1.0 license), the percentages in the likely license block 1006 may be 0-1% Creative Commons 1.0 license and 0-1% for the Open Audio 1.0 license.

The likely licenses block 1006 may include a threshold that is used to filter the licenses. For example, the filter may be set to 0.5%. Thus, any licenses that are identified that are below 0.5% of the total percentage of the training set of compositions 121 will not be included in the likely license block 1006.

The likely license block 1006 may include royalty information for the owners of AI generated composition 123. For example, the likely license block 1006 may show that a one-dollar royalty is due Artist X and a one-and-a-half-dollar royalty is due Company Y for each copy of the AI generated composition 123. Alternatively, the royalty information may be in a separate royalty block in the blockchain 131.

In addition, other blocks may be added that are not shown in FIG. 11. Another block that could be added is where the vectors (e.g., described in FIG. 4) for the similarity algorithm 124 are inserted as a block in the blockchain 131 (a vector block). If hashes or snippets are used (e.g., as described in FIGS. 5-6), the identified hashes/snippets could be stored in the blockchain 131 in a corresponding hash block or snippet block.

In addition, a copyright options block 1007 may be added to the blockchain 131. The copyright options block 1007 is used to track and/or control copies/sales of the AI generated composition 123. The copyright options block 1007 may include a maximum number of copies of the AI generated composition 123, a number of times a copy can be sold, whether or not a copy can be resold, a region where the AI generated composition 123 may be sold/resold, whether a copy can be printed, and/or the like.

For example, the copyright options block 1007 may indicate that only a single copy of the AI generated composition 123 may be sold. When the sale of the AI generated composition 123 is made, the transaction block 1008 is added to the blockchain 131. The transaction block 1008 indicates the person(s), company, or entity to whom the AI generated composition 123 was sold. Although not shown in FIG. 10, the transaction block 1008 may indicate that AI generated composition 123 was borrowed. For example, the transaction block 1008 may indicate that AI generated composition was borrowed to John Doe for a time of six weeks. In FIG. 11, the transaction block 1008 indicates that the AI generated composition 123 was sold to Jon Doe on Mar. 9, 2023. Although not shown, there may be multiple transaction blocks 1008 where the AI generated composition 123 was sold to multiple parties if the copyright options block 1007 permits resales and/or additional copies.

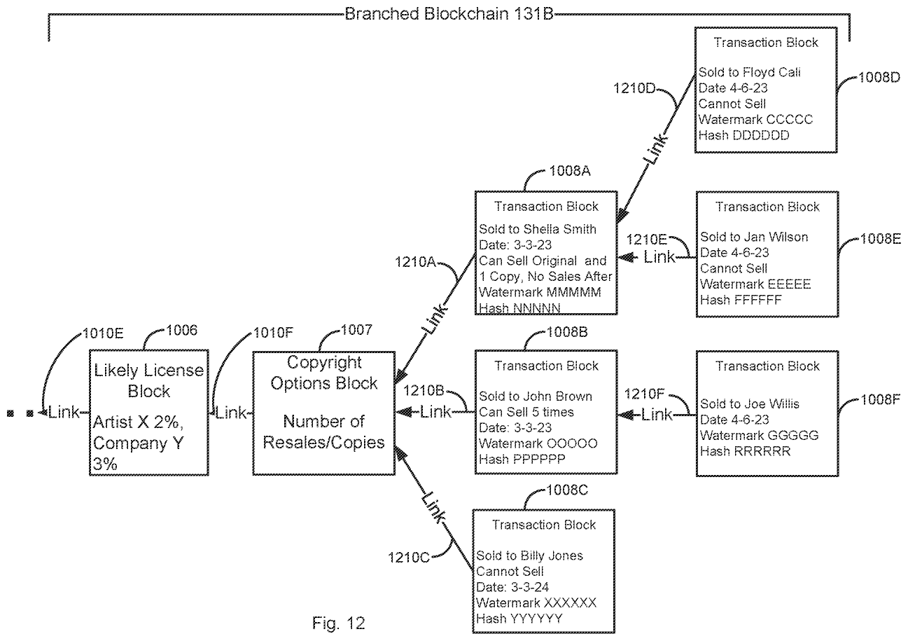

FIG. 12 is a diagram of a branched blockchain 131B for tracking ownership of copies of an AI generated composition 123. The branched blockchain 131B is used to track the AI generated composition 123 where there are multiple copies of the AI generated composition 123.

When multiple copies of the AI generated composition 123 are created and sold/exchanged a new branch in the branched blockchain 131B is created. For example, a copy of the AI generated composition 123 was sold to Shella Smith and the transaction block 1008A is added to the branched blockchain 131B. The transaction block 1008A links to the copyright options block 1007 via the link 1210A. The transaction block 1008A has the new owner (Shella Smith), the date sold (Mar. 3, 2023), an indicator that says Shella Smith can sell her copy and make one other copy to sell. The transaction block 1008A also indicates that no other sales can be made after Shella Smith sells her copy and the new copy. The transaction block 1008A also includes the watermark MMMMM (now in the AI generated composition) for Shella Smith and a hash of the media 103 with the watermark(s). The watermark is used to track unlicensed copies of the AI generated composition 123.

Shella Smith sells her copy and the additional copy. This causes the transaction blocks 1008D and 1008E to be added in different branches in the branched blockchain 131B. The transaction block 1008D is linked to the transaction block 1008A via link 1210D. Likewise, the transaction block 1008E is linked to the transaction block 1008A via link 1210E. The transaction block 1008D indicates that the new and final owner (cannot sell) of the AI generated composition 123 is Floyd Cali, it was sold on Apr. 6, 2023, has the watermark CCCCC, and a hash of DDDDDD. The transaction block 1008E indicates that the new and final owner of the AI generated composition 123 is Jan Wilson, it was sold on Apr. 6, 2023, has the watermark EEEEE, and a hash of FFFFFF. Jan Wilson does not have sales privilege for the composition.

Another copy of the AI generated composition 123 is sold to John Brown. This causes the creation of the transaction block 1008B. The transaction block 1008B is linked to the copyright options block 1007 via link 1210B. The transaction block 1008B indicates that the new owner is John Brown, that John Brown can sell five copies of the AI generated composition 123 (e.g., John Brown is a dealer of AI generated composition 123), that the AI generated composition 123 was sold to John Brown on Mar. 3, 2023, has a watermark of OOOOO, and a hash of PPPPPP.

John Brown sold one copy of the AI generated composition 123 to Joe Willis on Apr. 6, 2023, this copy of the AI generated composition 123 has the watermark GGGGG, and a hash of RRRRRR. This causes the transaction block 1008F to be added to the branched blockchain 131B. The transaction block 1008F is linked to the transaction block 1008B via the link 1210F. In this example, John Brown can sell four more copies at a later date, which would create new branches in the branched blockchain 131B.

A copy of the AI generated composition 123 was sold to Billy Jones. This causes the transaction block 1008C to be added to the branched blockchain 131B. The transaction block 1008C links to the copyright options block 1007 via link 1210C. The transaction block 1008C indicates that Billy Jones is the new owner, that Billy Jones cannot sell his copy of the AI generated composition 123, that the copy of the AI generated composition 123 was sold on Mar. 3, 2024, has a watermark of XXXXXX. and a hash of YYYYYY.

For the transaction blocks 1008A-1008F, the AI generated composition 123 has a current full chain-of-title; thus, each copy of the AI generated composition 123 may have watermarks that show the chain-of-title back to the licensors (e.g., the Artist X and Company Y). For example, the copy of the AI generated composition 123 sold to Floyd Cali (represented by transaction block 1008D) may have the watermarks of Floyd Cali (CCCCC) and Shella Smith (MMMMM). The transaction block 1008D may also include watermarks of the Artist X and the company Y. If there is only a single watermark, then the watermark for this copy of the AI generated composition 123 will be for the current owner (Floyd Cali in this example). If there is a partial chain-of-title, the watermarks of the partial chain-of-title will be in the copy of AI generated composition 123 owned by Floyd Cali. For example, the transaction block 1008D may include the watermarks of Floyd Cali CCCCC and the watermark of Stella Smith MMMMM.

If an unauthorized copy is in circulation, the blockchain 131 (includes any of the blockchains 131 described herein) can be used to identify an unauthorized copy by looking at who is the current owner (the last owner to store a transaction) in the blockchain 131. If the blockchain 131 shows that user 102A now owns it, but the watermark shows that user 102B is the current owner, you can flag this version as an unauthorized version that came from the copy that user 102B once owned.

In addition, the blockchain 131/131B may have additional data of what copyrights each copy of the AI generated composition 123 has. For example, a first purchaser may receive the right to play the AI generated composition 123 a number of times and a second purchaser may be able to play an unlimited number of times or for a period of time. The rights could only allow sales to specific persons or groups (e.g., a person's family). In other words, the blockchain 131 may track reproduction, adaptation, publication, performance, and display rights (those covered under copyright law).

In one embodiment, the blockchain 131 may be the source of validity. For example, the user 102 may have to present their watermark to a service that has the blockchain 131 in order to be able to use copy of the AI generated composition 123. This may be accomplished where the user 102 presents a digital certificate that then allows the user 102 to access/view/use the AI generated composition 123.

In addition, the process could be tied to edition size. For example, if the edition is only twenty copies. The blockchain 131 can track copies of the AI generated composition 123 to indicate that a specific user 102 has copy six of the total twenty copies. In this example, the blockchain 131 will only allow the initial owners/new owners go create twenty copies of the AI generated composition 123.

In addition, the information in different blocks 1000-1008 may be combined into a single block and/or into multiple blocks. For example, as discussed above the likely license block 1006 may include royalty information or there may be a separate royalty block that has the royalty information.

In addition, the order of how the different blocks 1001-1009 are added to the blockchain 131 may vary. For example, the user input block 1004 and the generated source composition block 1005 may be added in a reverse order.

While the above examples are discussed using a blockchain 131, the use of a blockchain 131 is not required or a single blockchain 131 may be used. The information of the blocks 1000-1009 may be stored in different tables and/or different records in the database 126. For example, the information in each block 1000-1009 may be stored as a separate record in the database 126. In this example, the license information 127 is stored in the records of the database 126.

If the AI algorithm 122 is retrained using a new training set of compositions 121, the blockchain 131 may be updated with new training information (e.g., a new training composition block 1002). The information could just include a delta. For example, if only a single training composition was changed, added, or removed, the delta would be only in the new training composition block 1002. In this example, there may be information indicating whether it was a change to a composition, a new composition, or a deleted composition. Alternatively, when the AI algorithm 122 is retrained, all the new training information may be added as discussed above. In one embodiment, a new blockchain 131 or a branch off the genesis block 1000 may be created using the new training information.

Although not shown in the blockchains 131/131B of FIGS. 10-12, the blockchains 131/131B may comprise additional information/metadata can be used to verify the different owners/borrowers of the AI generated composition 123. For example, digital signature information/certificates may be added to the blockchains 131/131B.

The systems/processes described herein may be part of a Software as a Service (SaaS) platform where individual entities submit their data to create centralized license information 127. The centralized blockchain 131 could be a private blockchain 131, semi-private blockchain 131, or a public blockchain 131.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various compositions of the system collocated, certain compositions of the system can be located remotely, at distant portions of a distributed network, such as a LAN and/or the Internet, or within a dedicated system. Thus, it should be appreciated, that the compositions of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the compositions of the system can be arranged at any location within a distributed network of compositions without affecting the operation of the system. For example, the various compositions can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or compositions/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
analyze an Artificial Intelligence (AI) generated composition, using a similarity algorithm, to identify a snippet of the AI generated composition that is the same or similar to a snippet of a composition used to train the AI algorithm;
identify license information associated with the snippet of the composition used to train the AI algorithm; and
generate licensing information for the AI generated composition that comprises the licensing information associated with the identified snippet of the AI generated composition.

2. The system of claim 1, wherein the similarity algorithm uses at least one of: a vector to identify the snippet of AI generated composition, a hash of the snippet of the AI generated composition, and the snippet of the AI generated composition.

3. The system of claim 1, wherein the licensing information comprises one or more of: information associated with a specific version of the AI algorithm, information associated with a specification version of the AI generated composition, information associated with a specific version of the composition used to train the AI algorithm, information associated with a specific time that input information was used to generate the AI generated composition, and the input information that was used to generate the AI generated composition.

4. The system of claim 1, wherein the license information comprises each of the following: a specific version of the AI algorithm, a specification version of the AI generated composition, a specific version of the composition used to train the AI algorithm, and input information used to generate the AI generated composition.

5. The system of claim 1, wherein the licensing information comprises at least one of: information about the AI algorithm, information about the composition used to train the AI algorithm, license information about the composition used to train the AI algorithm, likely licenses associated with the identified snippet of the AI generated composition, a hash of the snippet of the AI generated composition, the snippet of the AI generated composition, a vector generated by the similarity algorithm, input information used to generate the AI generated composition, the AI generated composition, information associated with the software application, testing information, source code removal information, and release information.

6. The system of claim 1, wherein the licensing information comprises a likely license associated with the AI generated composition.

7. The system of claim 6, wherein the likely license associated with the AI generated composition comprises a plurality of likely licenses associated with the AI generated composition that are displayed as varying percentages of the plurality of likely licenses.

8. The system of claim 1, wherein the licensing information comprises a vector generated by the similarity algorithm and wherein the vector generated by the similarity algorithm comprises at least one of: vector information generated by the similarity algorithm for the AI generated composition and matching vector information generated by the similarity algorithm for the composition used to train the AI algorithm.

9. The system of claim 1, wherein the licensing information comprises at least one of: a hash of the snippet of material generated by the AI algorithm and the snippet of material generated by the AI algorithm.

10. The system of claim 1, wherein the licensing information is stored in a blockchain and wherein the licensing information stored in the blockchain comprises at least one of: an AI algorithm block, a training composition block, a license block, a licenses filtered out block, a user input block, an AI input block, a generated composition block, a likely license block, a copyright options block, a royalty block, a transaction block, a vector block, a hash snippet block, and a snippet block.

11. The system of claim 1, wherein the licensing information is stored in a blockchain, wherein the blockchain comprises a plurality of transaction blocks that comprise a plurality of watermarks, wherein the plurality of transaction blocks comprises a chain-of-title for the AI generated composition, and wherein each of the plurality of transaction blocks identifies at least one of: a licensor, a previous owner, a borrower, and a current owner.

12. The system of claim 11, wherein each of the plurality of transaction blocks that comprise the chain-of-title for the AI generated composition further comprise a hash of the AI generated composition for each copy of the AI generated composition and wherein each copy of the AI generated composition has a different watermark associated with a current owner of each copy of the AI generated composition.

13. The system of claim 1, wherein the licensing information is stored in a blockchain, and wherein the blockchain comprises a plurality of branches that individually track individual copies of the AI generated composition and ownership of the individual copies of the AI generated composition.

14. The system of claim 13, wherein the plurality of branches track individual media rights for each of the individual copies of the AI generated composition.

15. The system of claim 1, wherein the licensing information is stored in a blockchain and wherein the blockchain tracks a maximum number of copies of the AI generated composition.

16. The system of claim 1, wherein the licensing information is stored in a blockchain and wherein the blockchain identifies a number of times a copy of the AI generated composition can be sold/transferred.

17. A method comprising:
analyzing, by a microprocessor, an Artificial Intelligence (AI) generated composition, using a similarity algorithm, to identify a snippet of the AI generated composition that is the same or similar to a snippet of a composition used to train the AI algorithm;
identifying, by the microprocessor, license information associated with the snippet of the composition used to train the AI algorithm; and
generating, by the microprocessor, licensing information for the AI generated composition that comprises the licensing information associated with the identified snippet of the AI generated composition.

18. The method of claim 17, wherein the similarity algorithm uses at least one of: a vector to identify the snippet of AI generated composition, a hash of the snippet of the AI generated composition, and the snippet of the AI generated composition.

19. The method of claim 17, wherein the license information comprises each of the following: a specific version of the AI algorithm, a specification version of the AI generated composition, a specific version of the composition used to train the AI algorithm, and input information used to generate the AI generated composition.

20. The method of claim 17, wherein the licensing information comprises a likely license associated with the AI generated composition.

21. The method of claim 20, wherein the likely license associated with the AI generated composition comprises a plurality of likely licenses associated with the AI generated composition that are displayed as varying percentages of the plurality of likely licenses.

22. The method of claim 17, wherein the licensing information comprises a vector generated by the similarity algorithm and wherein the vector generated by the similarity algorithm comprises at least one of: vector information generated by the similarity algorithm for the AI generated composition and matching vector information generated by the similarity algorithm for the composition used to train the AI algorithm.

23. The method of claim 17, wherein the licensing information is stored in a blockchain and wherein the licensing information stored in the blockchain comprises at least one of: an AI algorithm block, a training composition block, a license block, a licenses filtered out block, a user input block, an AI input block, a generated composition block, a likely license block, a copyright options block, a royalty block, a transaction block, a vector block, a hash snippet block, and a snippet block.

24. The method of claim 17, wherein the licensing information is stored in a blockchain, wherein the blockchain comprises a plurality of transaction blocks that comprise a plurality of watermarks, wherein the plurality of transaction blocks comprise a chain-of-title for the AI generated composition, and wherein each of the plurality of transaction blocks identifies at least one of: a licensor, a previous owner, a borrower, and a current owner.

25. The method of claim 24, wherein each of the plurality of transaction blocks that comprise the chain-of-title for the AI generated composition further comprise a hash of the AI generated composition for each copy of the AI generated composition and wherein each copy of the AI generated composition has a different watermark associated with a current owner of each copy of the AI generated composition.

26. The method of claim 17, wherein the licensing information is stored in a blockchain, and wherein the blockchain comprises a plurality of branches that individually track individual copies of the AI generated composition and ownership of the individual copies of the AI generated composition.

27. The method of claim 26, wherein the plurality of branches track individual media rights for each of the individual copies of the AI generated composition.

28. The method of claim 17, wherein the licensing information is stored in a blockchain and wherein the blockchain tracks a maximum number of copies of the AI generated composition.

29. The method of claim 17, wherein the licensing information is stored in a blockchain and wherein the blockchain identifies a number of times a copy of the AI generated composition can be sold/transferred.

30. A non-transient computer readable medium having stored thereon instructions that cause a processor to execute a method, the method comprising instructions to:
analyze an Artificial Intelligence (AI) generated composition, using a similarity algorithm, to identify a snippet of the AI generated composition that is the same or similar to a snippet of a composition used to train the AI algorithm;
identify license information associated with the snippet of the composition used to train the AI algorithm; and
generate licensing information for the AI generated composition that comprises the licensing information associated with the identified snippet of the AI generated composition.
